(19) United States
(12) Patent Application Publication
(10) Pub. No.: US 2008/0102169 A1
(43) Pub. Date: May 1, 2008

(54) Comestible product made with a grilling and baking process

(76) Inventors: David C. Rettey, Tracy, MN (US); Clifford Arthur Stubbs, Minneota, MN (US); Wayne M. Pafko, Marshall, MN (US)

Correspondence Address: MERCHANT & GOULD PC, P.O. BOX 2903, MINNEAPOLIS, MN, 55402-0903, US

(21) Appl. No.: 11/901,685

(22) Filed: Sep. 18, 2007

Related U.S. Application Data
(60) Provisional application No. 60/846,023, filed on Sep. 19, 2006.

(51) Int. Cl. A21D 13/00; A23L 1/10

(52) U.S. Cl. 426/87; 426/283

(57) ABSTRACT

A substantially planar food product comprises a farinaceous exterior with a filling interior. The substantially planar food has a farinaceous first surface and second surface with a filling formed therebetween. The edges can be sealed and the exterior surfaces of the food can be grilled. The fully grilled and cooked food can then be reheated in a toaster or toaster oven to provide a high quality sandwich-like product that has the appearance of preparation from fresh ingredients.

### FIELD OF THE INVENTION

The invention relates to a comestible substantially planar food product of specified length, width and thickness dimensions that can be cooked or heated in a toaster or toaster oven. The first aspect of the invention is a substantially planar food product while a second aspect of the invention is a method of making the food product. The food product can be prepared, substantially or fully cooked and frozen for preparation in a thermal convection oven, toaster oven or conventional toaster and can be conveniently consumed manually. Preparation in the home cooking equipment can introduce additional grill indicia. The preferred sandwich product obtains exceptional and surprising degree of quality in the nature of the bread components and substantial consumer acceptance.

### BACKGROUND OF THE INVENTION

A sandwich product having a sliced bread exterior and a filling is well known. Conventional toasted cheese sandwiches, grilled peanut butter and banana or grilled peanut butter and jelly sandwiches have been made in the household, conventionally, commercially for many years. Such easily prepared food items are extremely popular and of high demand.

Often, due to time constraints, the manual preparation of such food items cannot easily be accommodated in today's busy schedules. A number of proposed products of this general category have been proposed in the art. A number of such products, that can be heated in a toaster, are shown in for example, Blaetz et al., U.S. Pat. No. 3,719,138, who teach a sandwich made using conventional sliced bread and fillings wherein the structure is made stable by manipulating moisture activity; Allen, U.S. Pat. No. 3,656,968, who teaches a food product characterized as a sandwich in which a thin walled bun with a whole protruding into the bun to permit the addition of flavorings in concert with the filling; Barton et al., U.S. Pat. No. 3,656,967, who teach a two phase baked product having a humectant containing filling, a baked dough crust and carefully balanced moisture equilibrium to control moisture transfer during heating; Colvin, U.S. Pat. No. 3,539,354, who teach a sandwich method that obtains a product using a carefully coordinated combination of a container and bread with filling; Hong et al., U.S. Pat. No. 4,693,899, who teach a food using uncooked dough with a specified procedure and moisture control; Vermilyea et al., U.S. Pat. No. 4,207,348, who teach a sandwich like item for microwave heating involving a prefrozen interior filling material inserted into a dough envelope; Forkner, U.S. Pat. No. 4,171,380, who teaches a dough product with a frozen dessert filling using a specific backing layer and overlapping seam or edges; and Perrine, U.S. Pat. No. 6,231,898, who teaches a sandwich product made by carefully sealing peripheral portions of the edges of preformed bread slices surrounding a filling structure.

As you can see, a number of products adapted for toaster baking or cooking are known and a number of different product categories such as waffles, pastries, egg rolls, pizza, etc are available.

Many commercial offerings, as a sandwich product, fail to achieve a market success. Accordingly, a substantial need exists in the art for a high quality food product that can be characterized as a grilled sandwich having a high quality appearance, texture, taste and ease of preparation. Such products should not be dense, unsatisfying foods but should be light and crispy with a satisfying filling. They should not simply be toasted but have a “grilled” appearance and should be convenient for cooking in a toaster. The products should be attractive in appearance and provide excellent taste. The bread portion of the product should be crispy, have a grilled appearance arising from attractive areas of golden brown or seared markings on the food product. The product should be light, bready, have a grilled appearance and be convenient to cook and eat without substantial leakage of fillings during preparation or consumption. The fillings should be flavorful and easily manufactured into the product.

### BRIEF DISCUSSION OF THE INVENTION

We have found a substantially rectangular (including square) food product or a substantially circular food product in the form of a comestible product preferably resembling a sandwich-like product. The finished product is similar in some aspects to a toaster product or a sandwich-like. The product, however, is unlike other such foods due to the unique crispy texture and product configuration. The sandwich-like like food has two farinaceous layers with a filling there between and a sealed edge. The unique exterior has a bread crumb component and grilled farinaceous or bread dough layers with sealed edges formed in a combined baking and grilling process. The sealed layers form an envelope surrounding the filling and can maintaining the filling within the finished product. The product can be grilled during manufacture to form attractive grill marks. The food product before grilling and baking comprises a substantially planar food product having a circular or rectangular edge with substantially parallel and planar first surface and second surface derived from the farinaceous dough. The planar food comprises a first farinaceous surface and a second farinaceous surface with a filling placed therebetween. The filling is maintained within the food product by sealed edges. The food product of the invention has a product weight of about 75 to about 250 grams. The circular food product of the invention has a circumference of about 10 to 15 cm. The substantially rectangular food product of the invention has a length that can range from about 2 to 15 cm or about 10 to about 15 cm and a width that can range from about 8 to 12 cm. The filling thickness of the food product of the invention can range from about 0.1 to about 10, or 2 to about 4 millimeters and the overall food product thickness can range from about 0.5 to about 2.5 cm or about 0.6 to 1.8 cm. The filling weight is about 10 to 125 grams or about 25 to 50 grams. The first surface and the second surface of the planar food product are formed with grill indicia thereon such that the food product, after cooking in a toaster, has the appearance of a sandwich that is grilled conventionally by contact with heated grilling surfaces. The product can be made having dimensions adequate for toaster preparation.

The term “substantially planar” is intended to relate to a product made from planar ingredients. After cooking the materials can be somewhat distorted from the uncooked form by heating. The bready layers and the filling layers before cooking are substantially planar and are assembled into the product in that form. The products in the figures show that the filling portion within the bready layers cause the product to have a greater width across the filled region. Within that region the product is substantially planar within the limits of manufacturing or grilling and baking technology.

### BRIEF DESCRIPTION OF DRAWINGS

FIGS. 1-4 are process schematics of preferred embodiments of the process of the invention in forming dough sheets, adding breadcrumbs, providing a filling, forming an uncooked sandwich-like product, crimping and cutting the sandwich-like product, preparing the sandwich-like product for grilling, baking and packaging.

FIGS. 5-8 are photographs of the preferred embodiments of the sandwich-like product of the invention showing the interactive ground surface feature combined with the use of breadcrumbs imbedded in the crust to improve both product quality and processability.

FIG. 9 is a cross sectional depiction of the distribution of the bread crumbs in the product. The bread crumb aids in formation of a bready interior and a crispy exterior layer.

### DETAILED DISCUSSION OF THE INVENTION

The invention is a grilled food product made from components that are in a planar mode. The planar components can be assembled into a food that can be formed with a circular, rectangular, or square edge profile. The product is configured for rapid reheating in a toaster resulting in a product that appears to have been conventionally grilled on a hot grill surface.

The fillings used in combination with the planar food component of the invention are typically flowable or thickened, stable mixtures of materials. The typical formulation is often flowable but processes and cooks into a workable filling mixture and forms a substantially planar layer when introduced into the bready components.

The food materials that are combined in the formulations can include sweet materials including sugar, fruits, vanilla, chocolate, maple, etc. Savory ingredients used in the fillings can include such materials as meats, vegetables, eggs, cheeses, fish and other similar savory ingredients. The fillings can have an identifiable flavor character including Oriental, South Asian, Thai, Indian, Middle Eastern, Mediterranean, Mexican, Southwestern, Hawaiian, etc. Specific and easily identifiable formulations can be used in the invention including cheese, pizza fillings, peanut butter, peanut butter and jelly fillings, peanut butter and banana fillings, peanut butter and chocolate fillings, toasted cheese fillings, coconut, and coconut seafood, barbeque and variations, sausage and sausage combinations, vegetables and combinations, Black bean, etc. Sweet fillings include fruit, Chocolate, honey, honey walnut, etc. Sweet fillings can include whole fruits or fruit pieces, fruit puree, fruit jam, strawberries, raspberries, blueberries, cherries, blackberries, apples, pear, pineapple, apricot, sweet sauces such as pie filling, caramel, custard, etc.

The fillings are often thickened by using a water associating starchy material including such materials as a modified starchy component that can be obtained from a variety of sources. Such sources include maize, maize from a waxy source, corn, arrowroot, and other materials. Such starches and modified starches are known to be highly effective thickening materials that can render the filling handleable and easily cooked.

Savory fillings include a savory spiced toast, a savory meat filling, a savory fish, a savory egg formulation, a savory vegetable mix, a combination of vegetable pieces, cheese, spices, etc. Meats useful in the fillings of the invention include beef, chicken, turkey, veal, pork, prepared meat products such as ham, sausage, salami, pastrami, etc. Common firmer fishes can be used including salmon, sole, shrimp, lobster, in a raw piece form or in a cooked form. Vegetables that can be used in the filling include peas, tomatoes, peppers, mushrooms, onions, potatoes, carrots, celery, etc. Cheeses useful in the savory fillings of the invention include mozzarella, cheddar, parmesan, American, brie, gruyere and others. Sauce used with the fillings of the invention can include prepared materials including mustard, tomato sauce or tomato paste, ketchup, soy sauce, teriyaki sauce or other prepared flavored sauces or materials.

The preferred cheese component typically comprises a natural cheese or a processed cheese food comprising a blend of cheese, dairy protein, dairy fat, moisture and some amount of mineral character in a solid or semi-solid material. A natural cheese made from pasteurized or non-pasteurized dairy sources is preferred and is typically converted to a cheese using conventional cheese making technologies. However, the industry has developed a number of cheese materials that are equivalent to natural cheese made by blending dairy or non-dairy protein, dairy or non-dairy fat, inorganic supplements and other food grade materials into a material that is a substantial equivalent to natural cheese. This application should not be so narrowly construed that known cheese equivalents are excluded from the scope of the invention. The percentages disclosed herein are all based on the formulae content.

Cheeses used in the dough formulations can include Blue cheese, Mozzarella, provolone, Romano, Parmesan, jack and others. Commonly, cheeses in the form of shaved, crumbled or string form derived from mozzarella, Romano, Parmesan, provolone and whole milk or non-pasteurized cheeses can be used in the compositions of the invention. Cheeses, processed cheeses, cheese substitutes and cheese blends can be used both in the form of blended materials wherein two or more cheeses are blended and then applied to the crust. However, cheeses can also be added to the crust in layers without premixing.

Fillings are typically pre-made and are typically in the form of a material that can be extruded and applied to the uncooked dough surface in a solid, semi-solid or extrudable form. The fillings are typically shaped and configured for application to the uncooked dough such that the filling is registered on the dough leaving an edge for sealing purposes.

In the process of the invention, the sheeted dough is formed into dough portions approximating the size of the final product. The filling can be added to two layers of the dough product and the product can be formed by assembling the dough product with the filling in the interior of the product with sealed edges. Alternatively, the food product can be made by adding the filling to one portion of dough and forming the food product by assembling the second unfilled portion with the first filled portion in a sealed food product unit. The edges can be sealed or crimped and the product can be trimmed into a final shape or desired size.

The preferred food object of the invention has a bready exterior and a filling. The terms “bread”, “bready layer” and “bread dough” are used in this application generally refers to any commercially available yeast leavened, unleavened or chemically leavened material prepared from dough generally comprising flour, water and fat. The dough can if needed further contain eggs, fruit, nuts, sweetening agents such as sugar, honey, molasses, syrup, artificial sweeteners, etc. The flour employed can be a farinaceous material such as hard or soft wheat flour or other cereal flours and can, in certain doughs, include rye, oat, barley or other whole grain materials.

The leavening agents employed in the dough typically include yeast, chemical leavening agents commonly used in manufacture of breads. One important characteristic of the dough is that it can be manufactured in relatively large quantities, combined with bread crumbs and then manipulated as follows. The dough is sheeted into dough portions having a dimension of approximately 1 to 5 mm in thickness, preferably about 2 to 3 mm in thickness with a width of about 40 to 100 cm. Once formed into these sheet-like structures, the sheeted dough, in an uncooked form, is then divided into portions that approximate the size of the finished product. In order to aid in sealing the edges of the structure, a small amount of water spray is added to the dough surface either before or after division. At this stage, the filling can be added to the dough layer. Filling can be added to both sides of the ultimate sandwich-like assembly, however, for efficiency purposes', filling is typically added to one side of the finished assembly. The final assembly is completed by adding a layer of dough to the layer containing the filling. The edges are crimped and the product is then cut into final size.

The unique processability and texture characteristics of the finished sandwich-like product arise from the use of dried breadcrumbs on and in the bready layers. The dried breadcrumbs are incorporated into the bready layers by distributing the breadcrumbs throughout the bready layers. During the manufacture of the product, the breadcrumbs are added to either the exterior or to both surfaces of both the top and bottom layers of the product. As long as sufficient bread crumbs are located on the exterior of the product and are also distributed into the interior from the exterior surface, the product obtains the unique crispy character. During processing the breadcrumbs are imbedded into a surface of a farinaceous layer and are then distributed by processing steps, throughout the thickness of the dough. The presence of the breadcrumbs imbedded into the surface layer of the dough and distributed throughout the dough structure provides both an improved taste and texture and also improves the processability of the product. The heavily imbedded breadcrumb provides a desirable and unique crispness to the surface of the finished product after toasting by the end user at home and prevents distortion of the product from the substantially planar aspect due to blister or pillow formation during grilling baking or home heating.

Any dried breadcrumb can be used for use with the dough sheet. However we have found that toasted Japanese-style crumb is preferred for its texture and the texture it imparts to the dough layers. The granulation of the breadcrumb is important to assure good adhesion and to ensure that the breadcrumbs are imbedded into the dough structure. Having the breadcrumbs distributed throughout the dough structure ensures that the material will be crisp in the final product after toasting. A crumb with too fine a granulation will not properly imbed or distribute into or throughout the dough sheet and will not provide the desired crispness. A crumb which is too coarse results in an uneven surface distribution, poorly brown surface and undesirable texture.

The preferred crumb will have a particle size or granulation such that on a #8 U.S. sieve, 5±3 wt.-% is retained, on a #14 U.S. sieve, 38±8 wt.-% are retained, on a #20 U.S. Sieve 35±7 wt. % are retained with about 22±7% passing the #20 sieve. In another measure that less than 8% of the crumb has a particle size greater than about 2.5 millimeters. The crumb will have a particle size such that less than 30% of the crumb has a particle size less than 0.8 mm. The majority of the crumb will have a particle size that ranges from about 0.8 to about 2.5 mm. Preferably greater than about 50% of the crumb has a diameter that ranges from about 0.8 to about 2.5 mm more preferably greater than about 75% has a diameter that ranges from about 0.8 to about 2.5 mm. Preferred breadcrumbs are made by obtaining baked bread made from wheat flour containing appropriate leavening agents and also containing 2% or less of sugar and partially hydrogenated soybean oil, stabilizer salt, calcium propionate and other common bread additives.

Not only do the breadcrumbs provide taste and texture to the bread, the breadcrumbs also improve the processability of the bread structure. The presence of the breadcrumbs imbedded into the surface and throughout the dough layer ensures that the bread product does not “blister” or “pillow” during processing. Sheeted dough materials when they are grilled or baked often form large “blisters”, “pillows” or similar void spaces within the dough structure. These structures are formed by the influence of heat on moisture and other volatile components of the dough mixture. The volatile materials evaporate, expand and if trapped, form such pillows, blisters, bubble or void spaces within the dough layers. We have found that the breadcrumb materials distributed throughout the dough layers prevent the formation of an enclosed space by interrupting the dough structure through the periodic placement of the breadcrumb particles throughout the dough layer. The crumb prevents trapping of the volatile materials in the dough. Thus surprisingly the texture of the product is improved along with an improved processability of the product. Indeed highly “pillowed” or “blistered” products would not pass quality control requirements and could not be packaged and sold.

The amount of breadcrumb imbedded in the dough has a significant effect on the extent of pillowing in the oven as well as improved texture in the product. The amount of breadcrumb used in the product of the invention can range from about 1 to about 6 wt.-% based on the dough product excluding the fillings. The texture and processability can be obtained in amounts of breadcrumb ranging from about 2 to about 4 wt./% based on the dough centered around 3.5% plus or minus 0.5% breadcrumbs. Crumb add-on can be monitored by placing on a conveyer line or on the product itself, an 8.5 inch diameter container sized and configured to collect breadcrumbs deposited on the conveyer. The crumb add-on is adjusted such that crumbs collected on an 8.5 inch diameter container is about 60 to 90 grams at the first crumb add-on station and about 6 to 10 grams at the second station.

The method of crumb addition is unique and obtains excellent texture and processing characteristics. The crumb is deposited on one half of the sheeted dough at a first crumb depositer station. This added on portion of the dough becomes either the top exterior or the bottom exterior of the product. After this add on is complete, the dough is laminated and about 5 to 8 inches in depth (dough thickness). The crumb at this position is about 0.5 to about 0.75 inches in depth across the top of the laminated dough sheet. This crumb passes through four sets of reduction rollers resulting in a portion of the crumb forming embedded zone in the dough surface with some proportion being forced below the surface of the primary dough mass into the dough interior. This dough mass will eventually be split to form both top and bottom sheets of the finished raw dough sheeted product. If added to the entire sheeted dough, the crumb can be present on both surfaces of the top portion of the dough and both surfaces of the bottom portion of the dough and throughout the dough layers. Alternatively, the crumb can be used on a single surface, either the top or the bottom or both, of the product and in the dough interior. The subsurface crumb substantially reduces pillowing and improves the texture of the product. In this way the crumb appears imbedded in the upper exterior surface embedded in the lower exterior surface and is deposited throughout the dough structure.

At the second crumb add-on station, further crumb is deposited onto the surface of the sheets such that it is surface imbedded in the top sheet side of the top sheet. The substantial portion of this crumb is imbedded in the top surface of the dough sheet and provides crispness at the exterior imbedded locations of the top and the bottom layer in the finished product. Bread crumbs in an amount of about 6 to about 20 grams of bread crumbs per pound of the sheeted dough is added. Bread crumbs can be added to both planar surfaces of the sheet prior to further processing.

The unique product quality of the planar food product of the invention can be obtained using a method of making the planar food that is novel and unique. The use of the bread crumb in the farinaceous layers obtains a unique crispness to the product not present in previous foods. The Crumb also permits the formation of a unique structure in the farinaceous layer. The crumb is placed on the exterior of the sheeted dough and during processing is imbedded into the dough. The crumb and the processing form a product with two regions in the product. In the layers where the crumb predominates the crust obtains a crisp external character. In the interior where the amount of crumb is reduced, the bread is tenderer. The crisp portion and the tender portion comprise a fraction of the thickness of each exterior layer and can comprise about 5 to 90% of the layer thickness. Each crisp and tender portion can separately be about 0.1 to 5 mm often about 0.7 to 3 mm. This unique structure highly desirable and is a surprising result of the food technology of the invention. The method of making the planar food product comprises forming a planar food having a first farinaceous side and a second farinaceous side with a filling placed there between, the planar food having a sealed edge. In order to facilitate grilling, both sides of the food product can be contacted with an oil spray in an amount of about 4 to about 8 grams of oil spray per unit of product or about 1 to 10 milligrams of oil per gram of product.

The food product is then grilled by passing the food through a continuous grilling station and contacting each side of the planar food product simultaneously with an appropriately positioned grill surface such that the planar sides of the food product are simultaneously grilled forming grilled indicia on both sides of the product. The planar food is simultaneously contacted with heated spaced apart grill surfaces, the surfaces each having at least a heated grilling portion and is grilled in a continuous process as the food passes between the grilling surfaces. The surfaces are heated to a temperature sufficient to form a grilled or browned surface on the exterior planar sides of the food. During heating with the heated sides, the food product tends to expand. In order to avoid introducing unwanted shear or other disruptive forces onto or into the cooking product, the spaced apart planar heating sides are spaced such that the intake portion of the spaced apart heated sides is at a first dimension and the exit of the spaced apart heated sides are at a second, but increased spaced apart dimension. Since the food product as it enters the grilling zone is substantially uncooked. Such a product will rise as it contacts the heated surface. Accordingly, to prevent undesirable compaction of the food product, the spacing between the grill surfaces is increased as the food product passes from the entry to the grill to the exit of the grill. Typically, with a food product having a thickness of about 0.8 to about 1.0 cm on entry, the grill entry has the grilling surface separated by about 0.9 to about 1.1 cm with the grill exit space at about 1.3 to about 1.5 cm. The inlet side is at least 10 mm to 2 cm less in separation than the separation of the outlet side. Typically, the grill is substantially planar and has a smoothly changing profile as the food product passes in a linear path from the entry to the exit. The overall purpose of this step is primarily to obtain grill indicia and to initiate baking of the farinaceous food component of the food product and to simultaneously introduce grill indicia on the surface of the product. The product is not fully cooked at this step, but is only partially cooked forming the desirable grill markings on the planar surfaces of the product. Prior to the contact of the food with the heated sides, an oil spray is directed to the first side and the second side to prepare the food product for grilling. Prior to grilling, the food product is assembled by first forming a farinaceous layer, used for the exterior of the food product, by sheeting dough, dividing the dough into portions, adding filling to every other portion in an intermediate fashion forming a plurality of filled portions and a plurality of unfilled portions and then forming the uncooked planar food product by placing an unfilled portion on the filled portion forming a filling layer between the sheeted portions and sealing the edges.

The planar food is contacted with the first heated side and the second heated side of the grill station simultaneously at a temperature of about 160 to about 300° C. for at least 10 seconds or preferably about 200 to about 285° C. for about 10 to 35 seconds to obtain a grilled surface. Once grilled, the planar food is then conveyed to and is heated in a baking zone at a temperature of about 150 to 300° C. for about 1 min. to about 10 min. in order to fully cook the farinaceous layers and the filling in the product. The baking process can be in a zoned baking chamber having a first zone at a different temperature than the second zone. The second zone can be at least 5° C. higher or lower than the first.

Once fully cooked, the product can be physically or mechanically compressed to a desirable thickness and can then be packaged, frozen, pelletized and stored prior to shipping to retail outlets. The final product preferably has an overall product thickness of about 12 to about 19 millimeters, a filling thickness of about 3 to about 9 millimeters and has a generally rectangular (including square) or circular edge profile.

### DETAILED DISCUSSION OF THE FIGURES

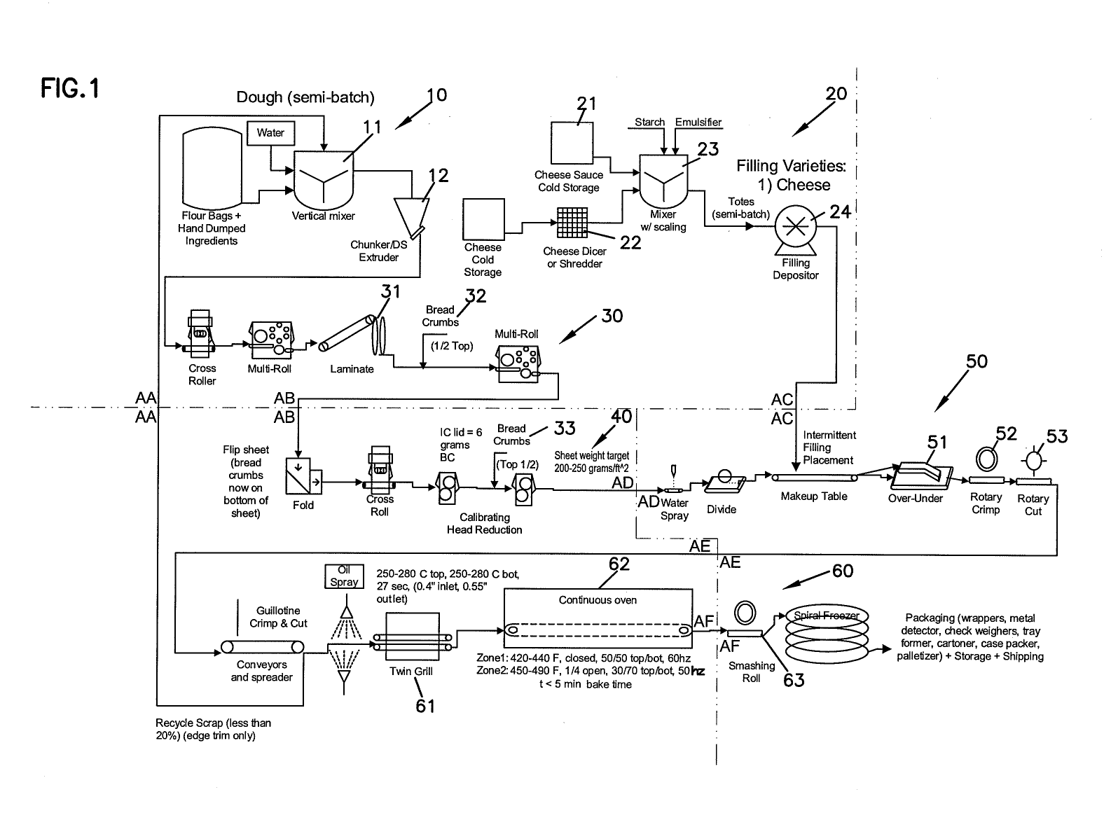

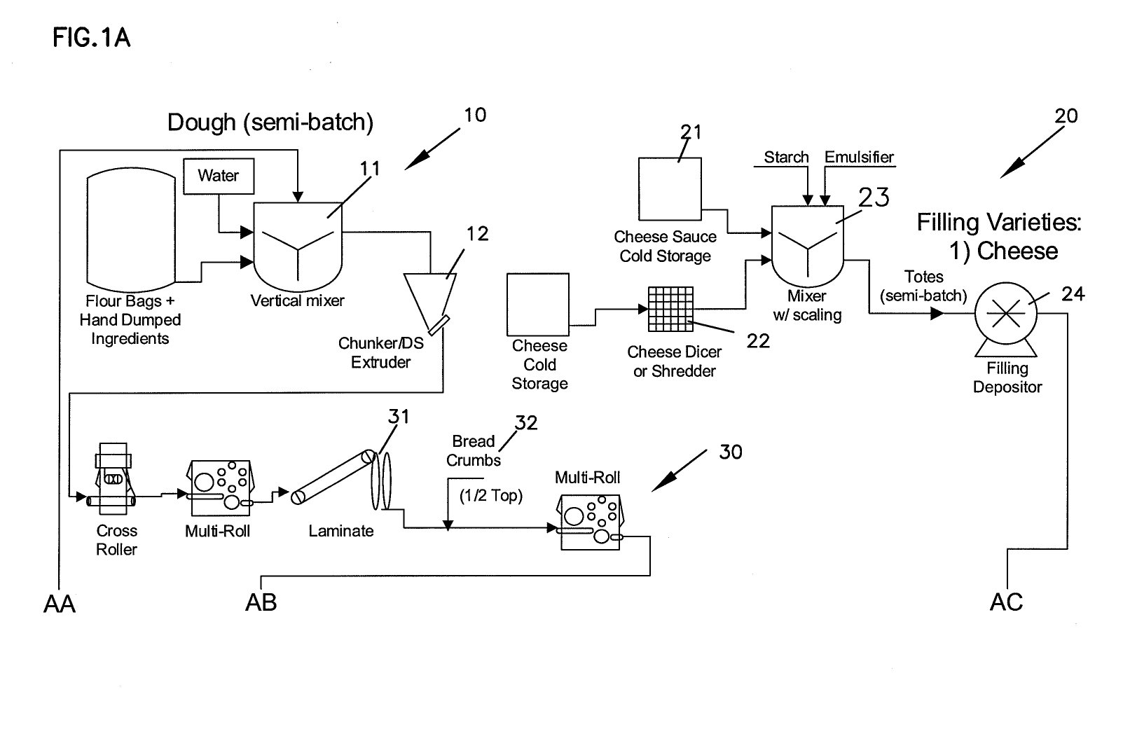

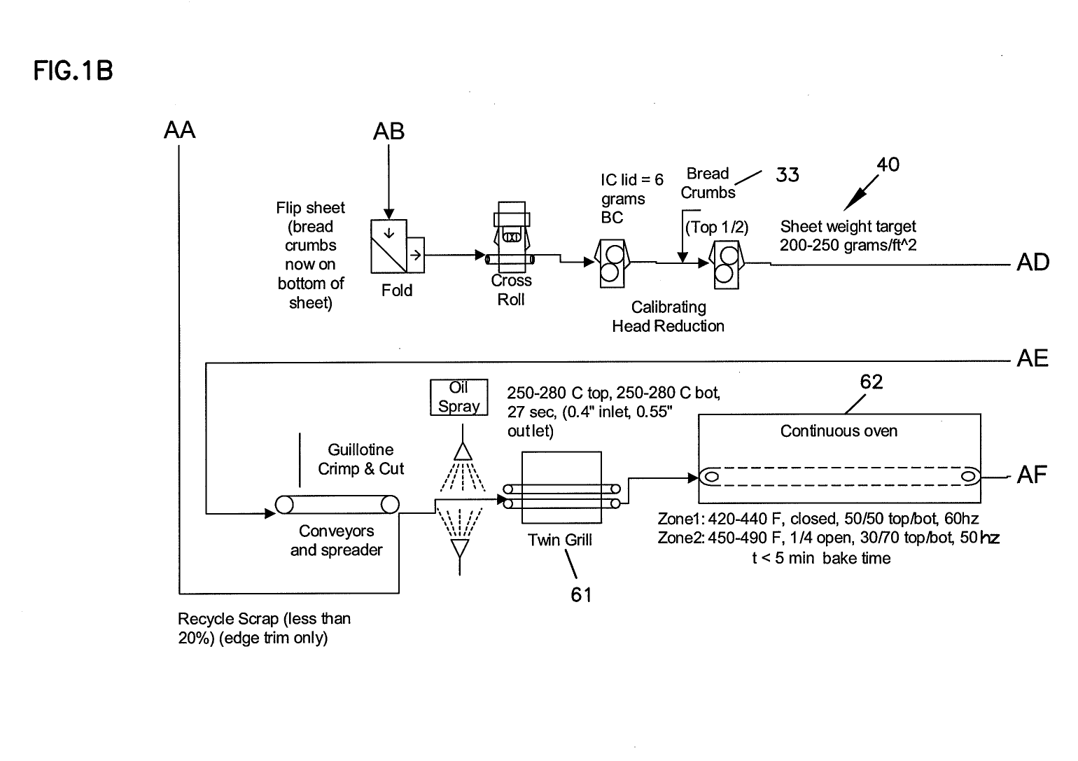

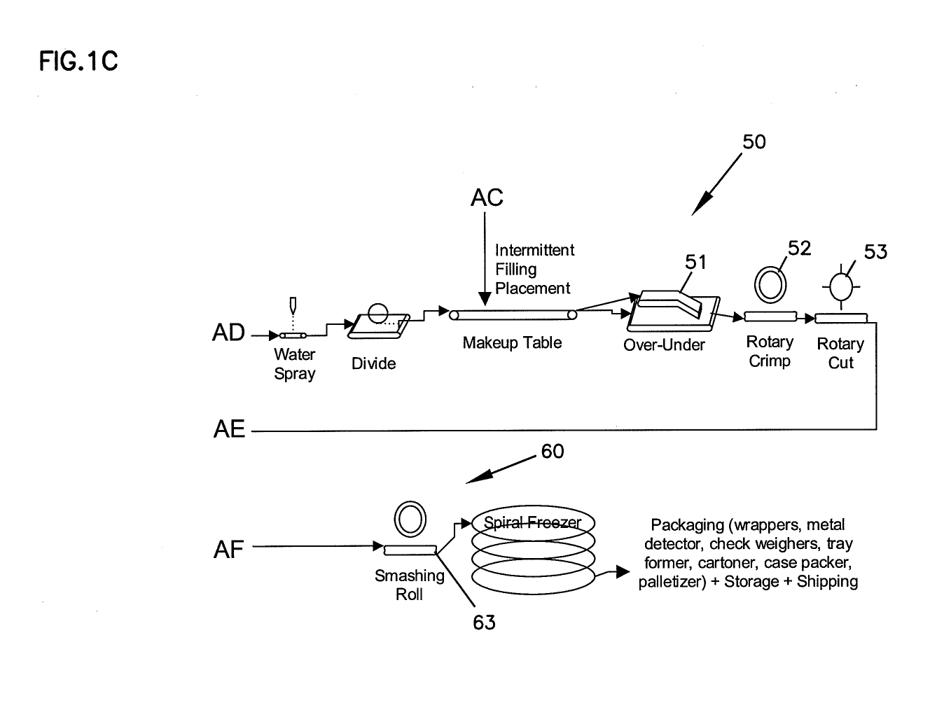

FIGS. 1-4 are process flow diagrams of preferred embodiments of a process for forming the grilled sandwich-like product of the invention. Each of FIGS. 1-4 are similar through the formation of the uncooked sandwich-like product. In all processes, the dough is sheeted, crumbs are added to and imbedded and distributed throughout the product. Crumbs are added to both sides of the sheeted dough. After the crumbs are distributed throughout the dough product, a filling is added, and the products are closed and sent to a cooking station. The sandwich-like products must be sufficiently cooked for both hygienic and appearance purposes.

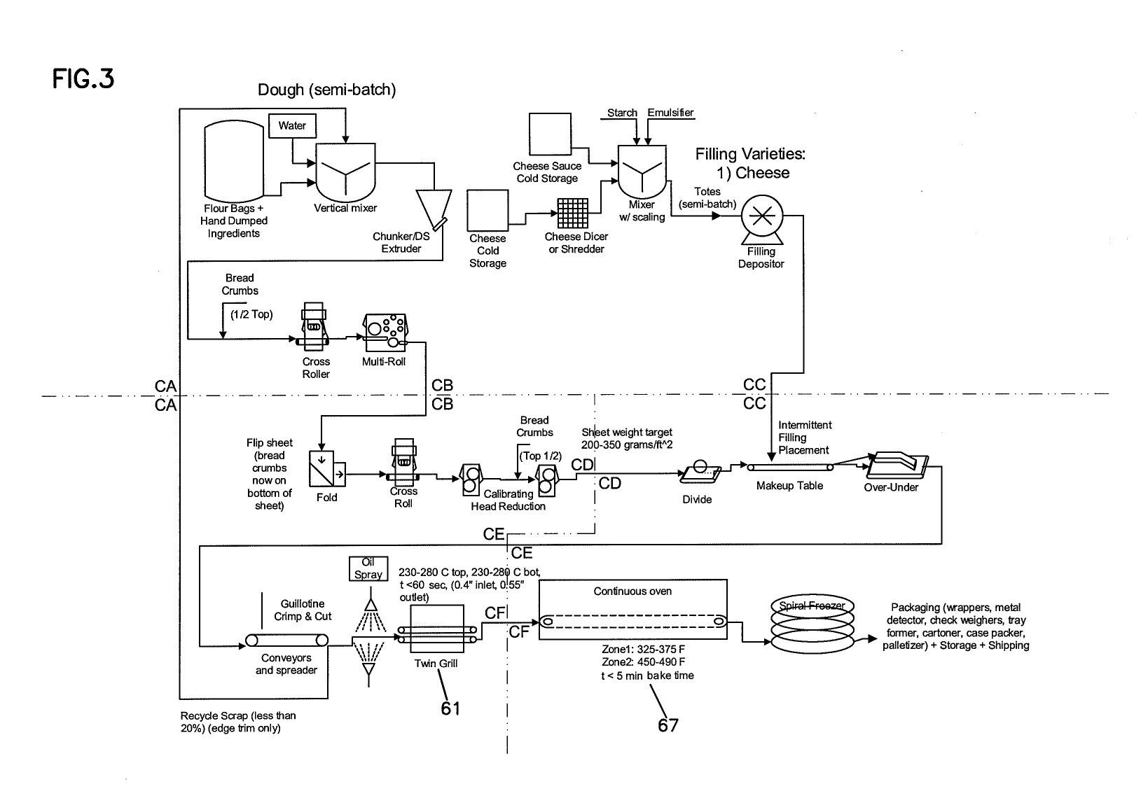

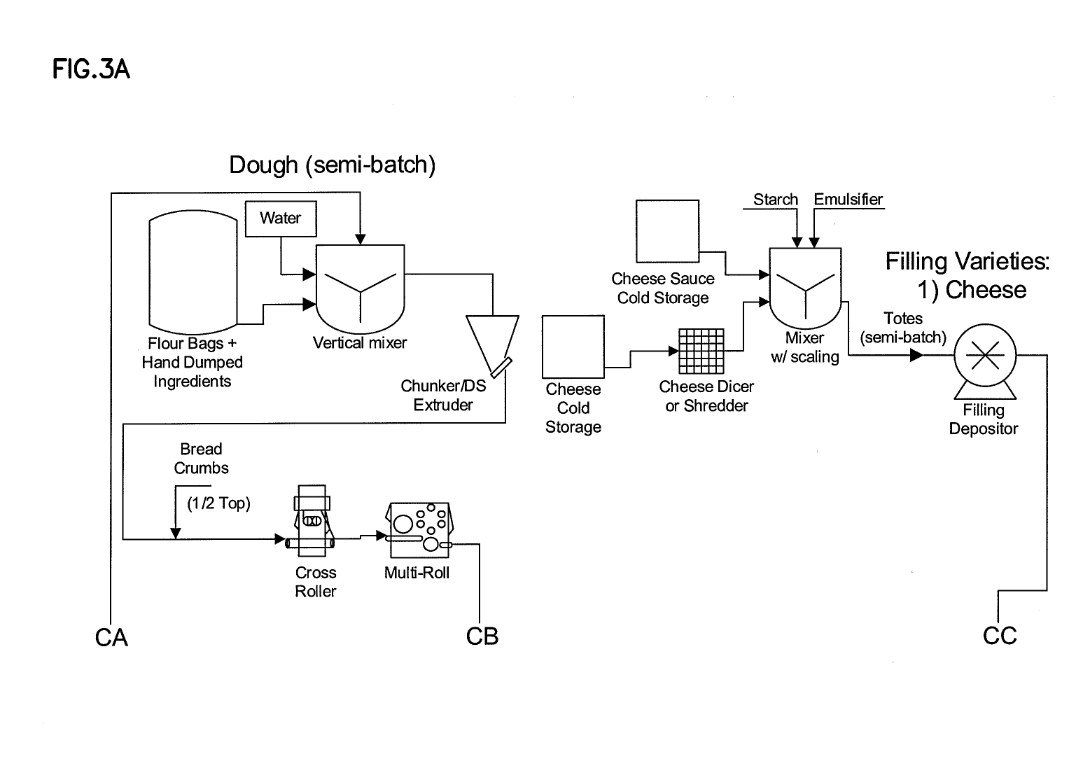

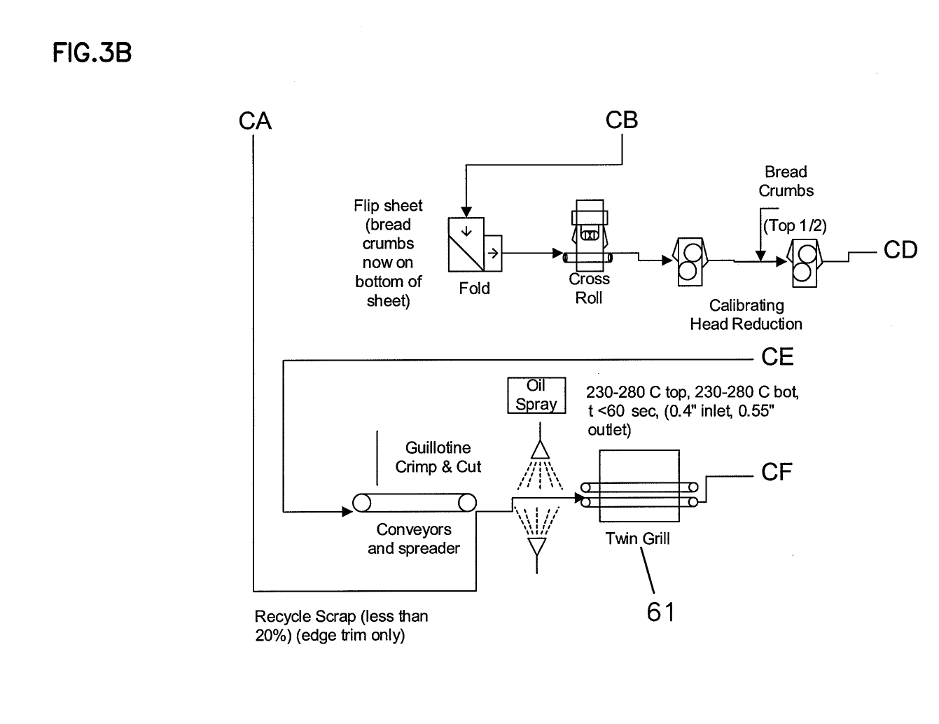

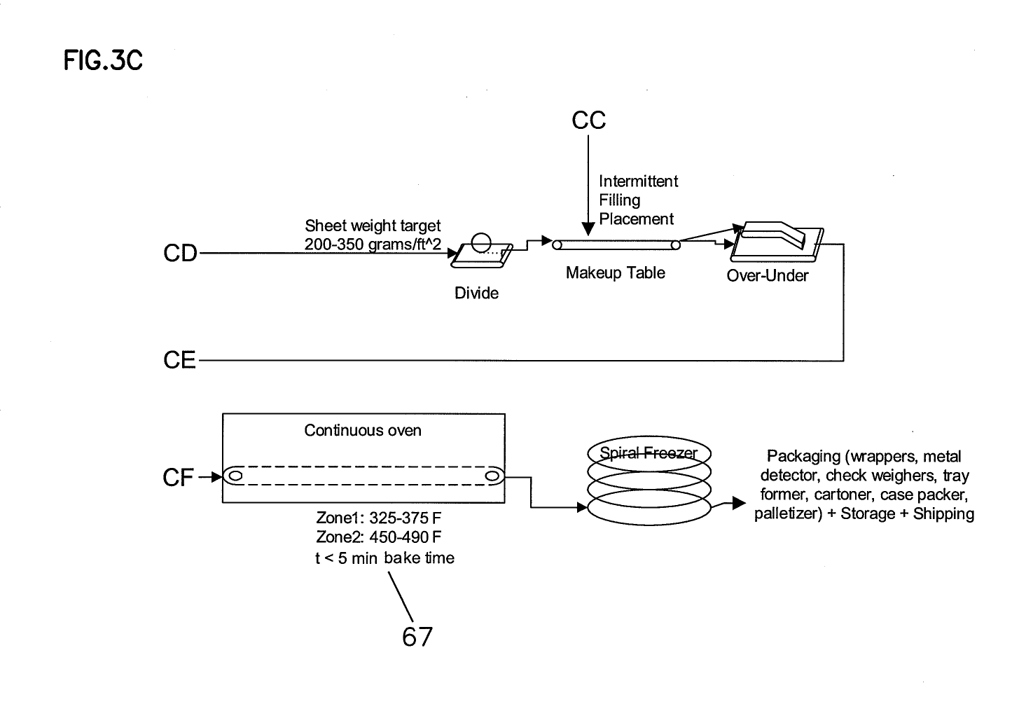

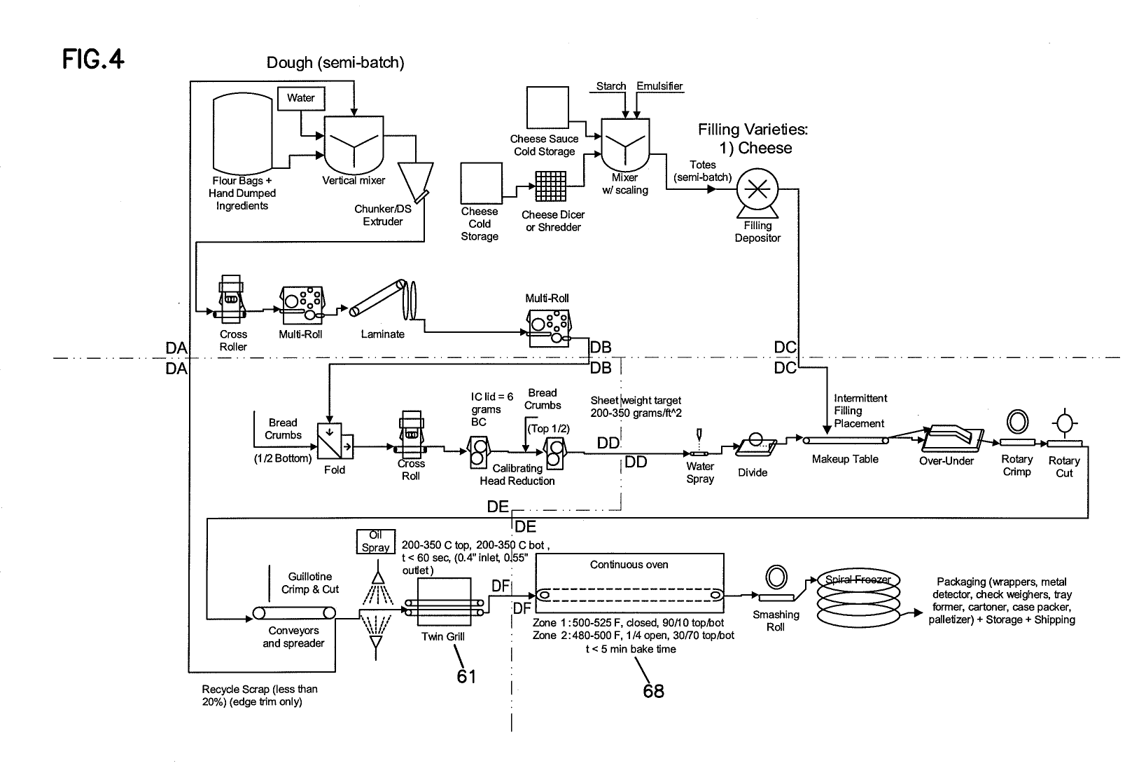

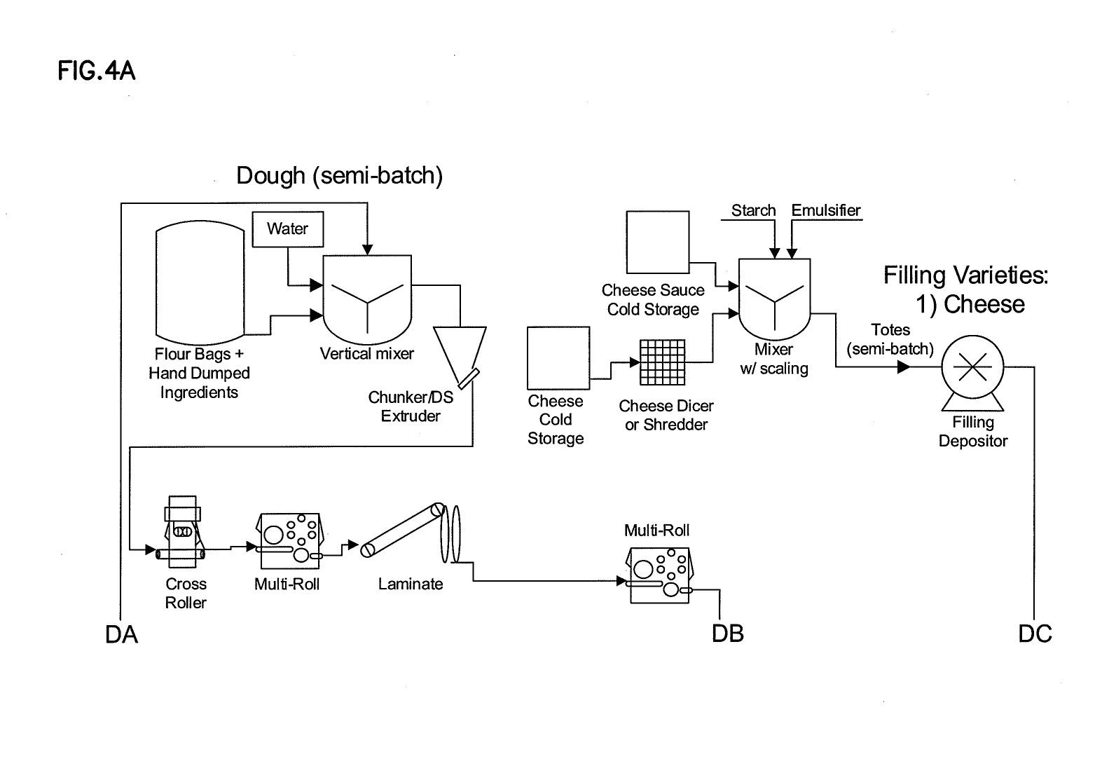

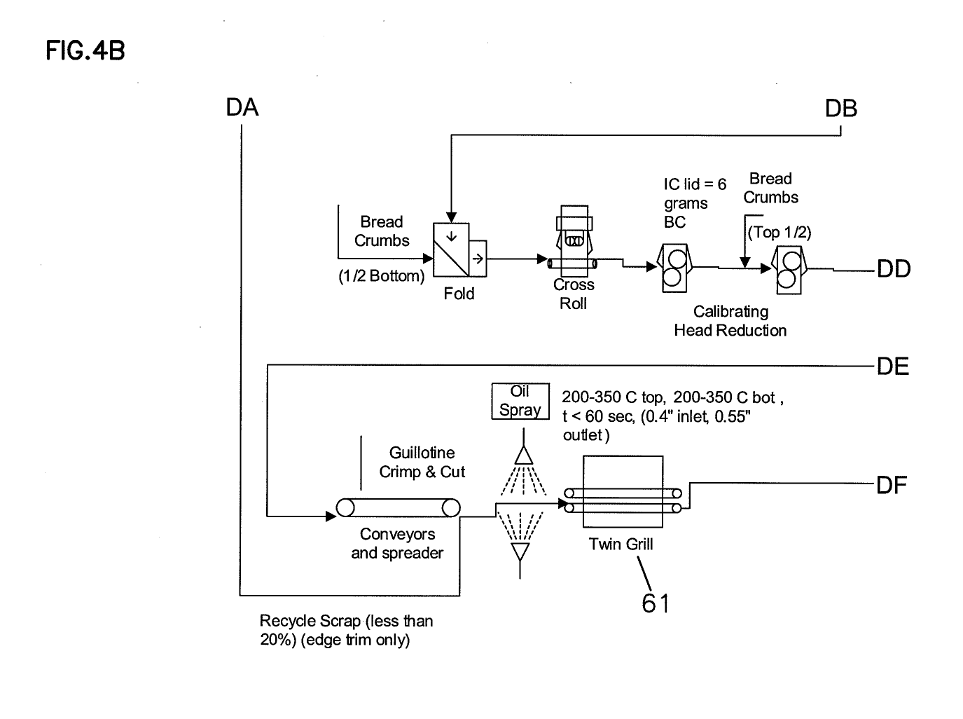

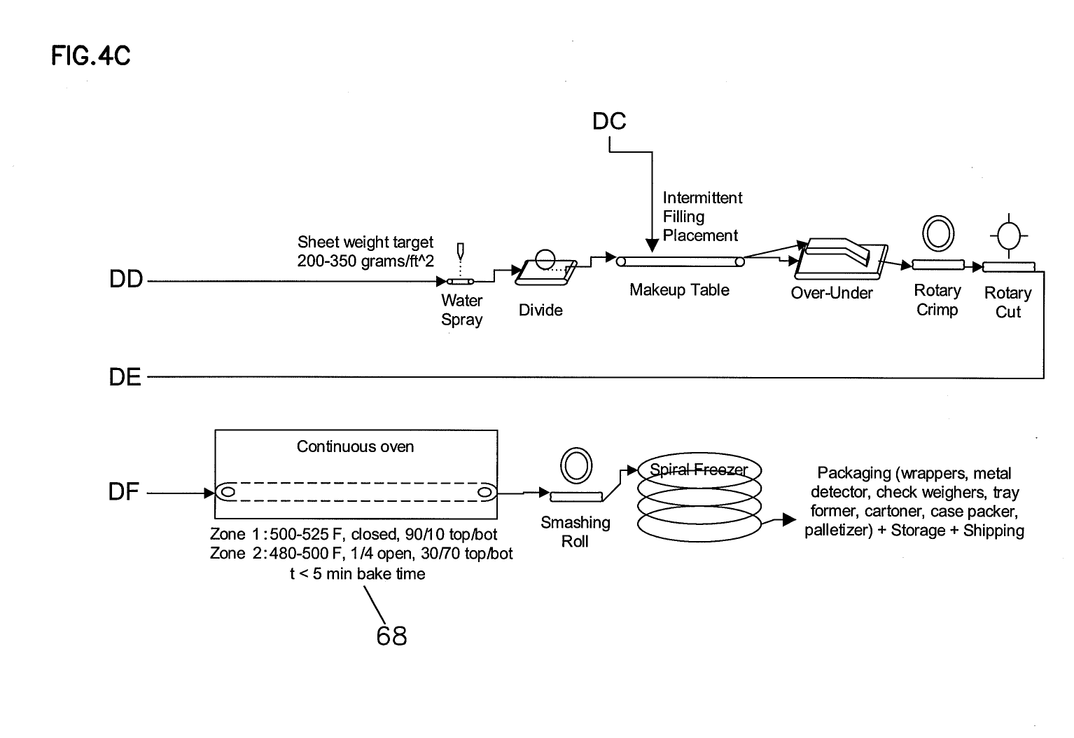

Briefly, in the process of FIG. 1, the sandwich-like products are grilled in a twin grill cooking station that grills both sides of the sandwich-like product simultaneously. The grilled sandwich-like product is then passed through a continuous oven in which the sandwich-like product is fully cooked throughout. After baking, the sandwich-like product is then compressed in a smashing roll to an appropriate size. The sized sandwich-like product is then packaged and frozen. In a second preferred embodiment of the process, the sandwich-like product is first baked in a continuous oven then grilled top and bottom. The grilled sandwich-like product is then corrected for size and is packaged and frozen. In a further embodiment showing FIG. 3, the product is grilled top and bottom. The sandwich-like product is then baked but is then immediately packaged and frozen without size modification. In a final embodiment in FIG. 4, the sandwich-like product is grilled, top and bottom in the twin grill station. After leaving the twill grill station the product is then baked in a continuous oven. The baked product is then sent to the size reduction station and is then packaged and frozen. The overall process is shown in FIG. 1. The dough is prepared in station 10 in which flour and water is combined in a vertical mixer 11 until uniform. The prepared dough is then transferred to a chunker extruder station 12. While the dough is being prepared, a filling is prepared. FIG. 1 exemplifies a cheese filling, however other fillings can be similarly processed and prepared for placement. In the process of the invention, liquid cheese sauce 21 and solid cheese portions 22 are prepared. The cheese sauce is combined with solid cheese in a mixer 23. The solid cheese is diced or shredded and combined with the cheese sauce to produce a pumpable or depositable thick liquid or semi-solid cheese filling mixture. The cheese mixture is added to the dough as a filling 24. The filling is deposited on an appropriately sized dough sheet.

Such dough sheets are made by first rolling the product of the dough station 30. The dough is rolled laminated at station 31 to form a multi-laminate dough having 2 to 30 laminations. The breadcrumbs are added at station 32 to the dough and the breadcrumbs and dough are then passed through a multi-roller operated under conditions such that the breadcrumbs are uniformly distributed within the dough sheet. The sheet is then flipped or reversed and breadcrumbs are added at station 33 to the other side of the sheet to ensure that both exterior sides of the dough sheet are heavily incorporated with breadcrumbs. After sheeting at station 40, the weight of the sheet is approximately 250 grams of dough per square feet of sheet.

A small amount of water is sprayed onto the dough sheet to act to promote adhesion when the sandwich-like products are combined. The sheet after the water spray station is divided into two portions.

The cheese filling from station 24 is then applied to a dough portion. In section 50, the corresponding divided dough portion is then placed at station 51 on top of the filled portion. The filled materials are crimped to adhere the periphery of the dough sheets and the crimped material is then cut to size at stations 52 and 53.

The product is then sprayed with oil to prepare it for cooking. In the first embodiment of the process shown in FIG. 1, the sandwich-like product is then grilled, top and bottom in the twin grill station 60 using grills 61. The twin grill is operated at a top temperature of 250-280° C. top, 250-280° C. bottom. Cooking is continued for 15-30 seconds. The grill is set at a specific tapered separation such that the sandwich-like product is not substantially compressed during grilling. The tapers from a close separation to a more distant separation during grilling to ensure that as the sandwich-like product is grilled and is expanded by cooking that the grill does not overly compress the sandwich-like product. Accordingly, the inlet separation between grill surfaces is a dimension that is less than the outlet dimension.

The grilled sandwich-like product is then directed into a continuous oven section 62 in order to complete the cooking process. The grill section provides attractive grill marks on the exterior of the sandwich-like product while the oven finishes the cooking process of the bread and filling. The continuous oven has two zones often operated at different temperatures. In the preferred mode, zone 1 is operated at a temperature from about 420-440° F. (215-227° C.). Zone 2 is then operated at a higher temperature typically about 450-490° F. (232-255° C.). The double time of residence within the continuous oven is less than 5 minutes and is typically about 2-3 minutes.

Once fully cooked, the product thickness is then adjusted at station 63 such that the product is passed underneath a roll to adjust thickness. The uniform resulting product is then packaged and frozen.

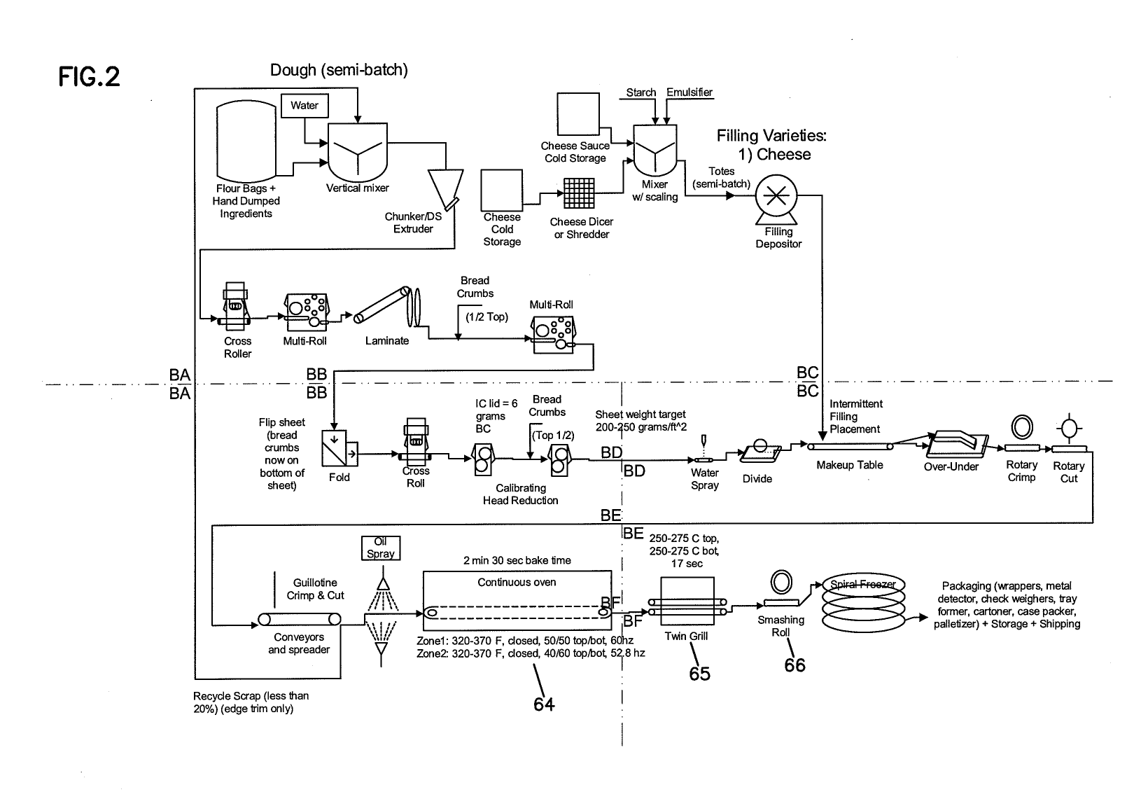

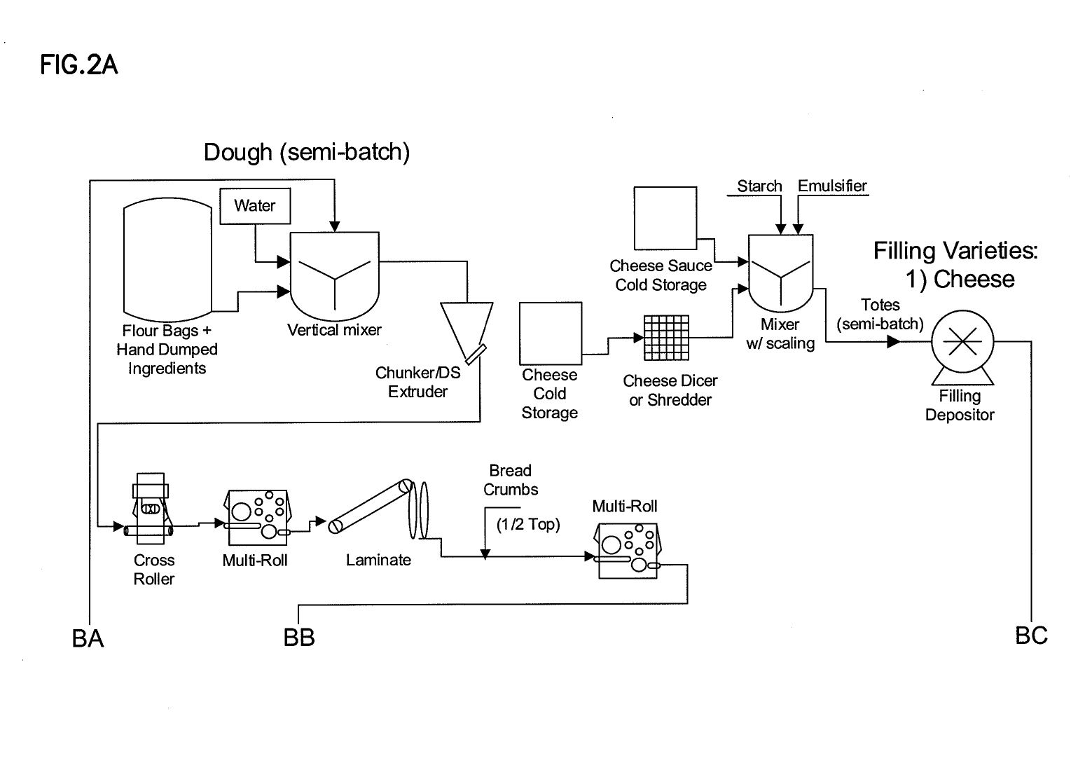

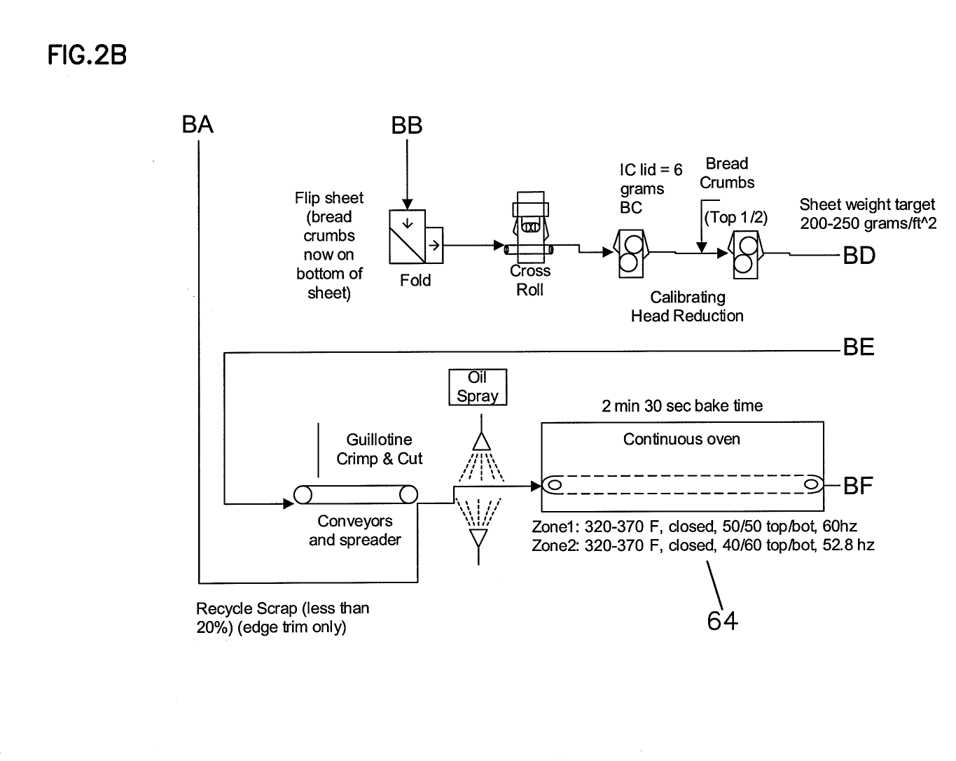

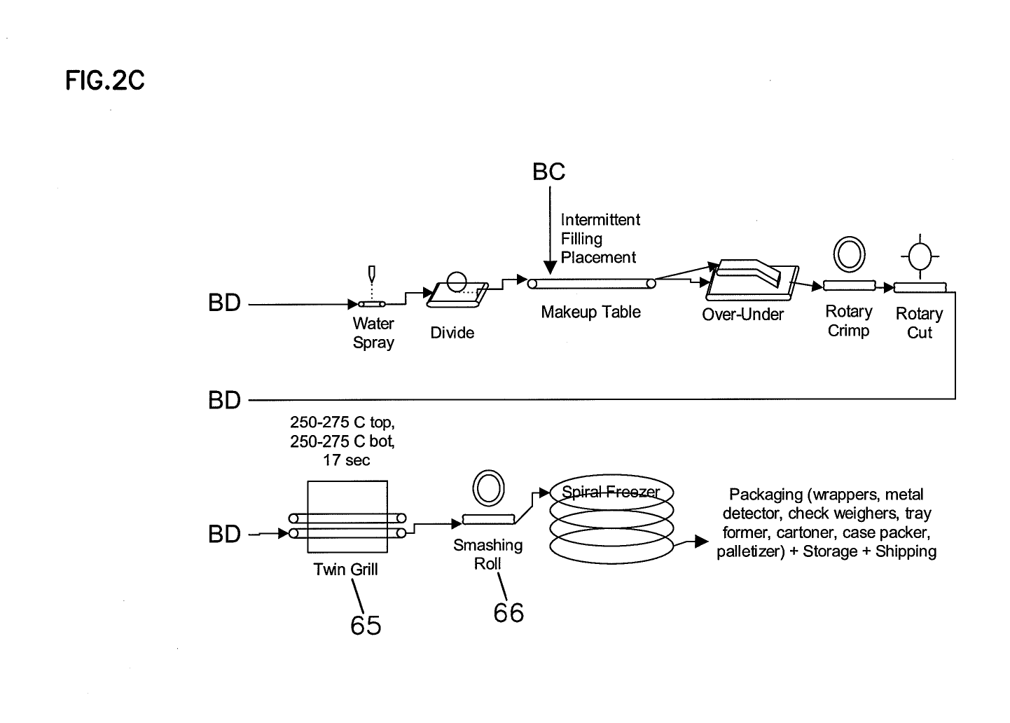

In the preferred embodiment of FIG. 2, the uncooked sandwich-like product is cut to size and sprayed with oil. After oil is added, the sandwich-like product is then directed to a continuous oven 64 wherein it is baked in two zones for a time of less than 2 minutes and 30 seconds. Zone 1 is operated at 320-370° F. (160-190° C.) and zone 2 operated at 330-380° F. (165-195° C.). After the product is baked, it is then passed through a twin grill station 65 in which the product is then grilled. The combination of the continuous oven and the grilling station fully cooks the dough and the filling and provides and attractive grilled appearance to the product. Both the top and the bottom grill surface are operated at a temperature that ranges from about 250-275° C. and the residence times in the grill station are 17 seconds. In this embodiment, the separation between the top and the bottom grill portions is the same at the grill entrance and the grill exit. In this embodiment, the thickness of the product is then made uniform at a roll station 66 in which the product is then rolled to a uniform thickness, the product is then packaged and frozen.

In the preferred embodiment shown in FIG. 3, after the oil is sprayed the sandwich-like products are first grilled top and bottom in a quick drain grill station. In that station, the top and bottom grills 61 are operated at a temperature that ranges from about 230-280° C. with a residence time of about 60 seconds. In this embodiment, the grill inlet is about 0.4 inches while the grill outlet is about 0.55 inches which allows for product expansion and ensures that the product is not overly compressed in the grill stage. The grill station introduces attractive grill marks onto the breading surfaces. The grilled product is then baked in a continuous oven 67. The oven has two zones. A first zone operated at 325-375° F. and zone 2 is operated at 450-490° F. with a bake time of less than about 5 minutes. This product has not been modified in thickness and is then immediately packaged and frozen.

In the last embodiment shown in FIG. 4, the product after the oil spray is grilled top and bottom at a temperature of about 200-350° C. at a residence time of less than 60 seconds. The grill 61 is operated with inlet distance of separation of about 0.4 inches while the outlet dimension is set at 0.55 inches. The grilled product is then sent to a continuous oven 68 operated with two zones. Zone 1 is operated at a temperature of about 500-525° F. (260-275° C.) while the second zone is operated at a temperature of about 480-550° F. (250-290° C.) with a residence bake time of less than 5 minutes. The product thickness is then adjusted at a roll station and the product is then packaged and then frozen.

The patent or application file contains at least one drawing executed in color. Copies of this patent or patent application publication with the colored drawings will be provided by the office upon request and payment of necessary fees.

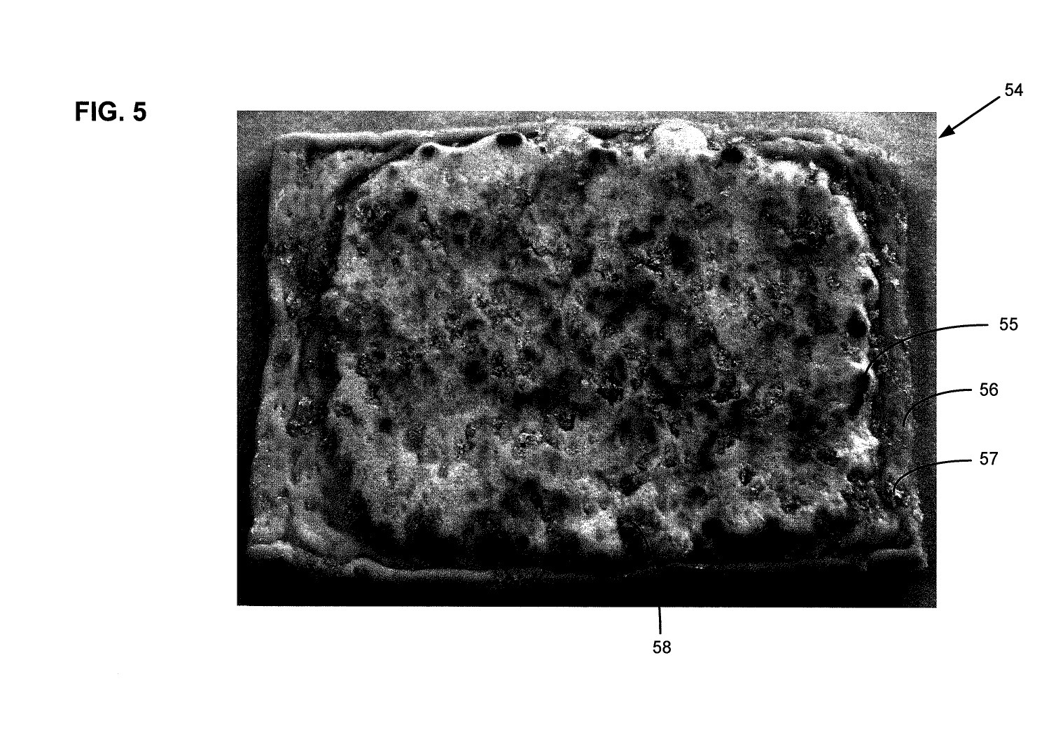

FIG. 5 is a color photograph of the product 54 of the invention showing grilled indicia 55 on the exterior of the filled portion 55 of the food 54. The overall aspect of the filled portion 55 is planar. The sealed edge 56 holds the filling in place. The sealed edge 56 has exterior bread crumbs 57 on the edge portion. The surface of the filled portion 55 has embedded brad crumbs 58.

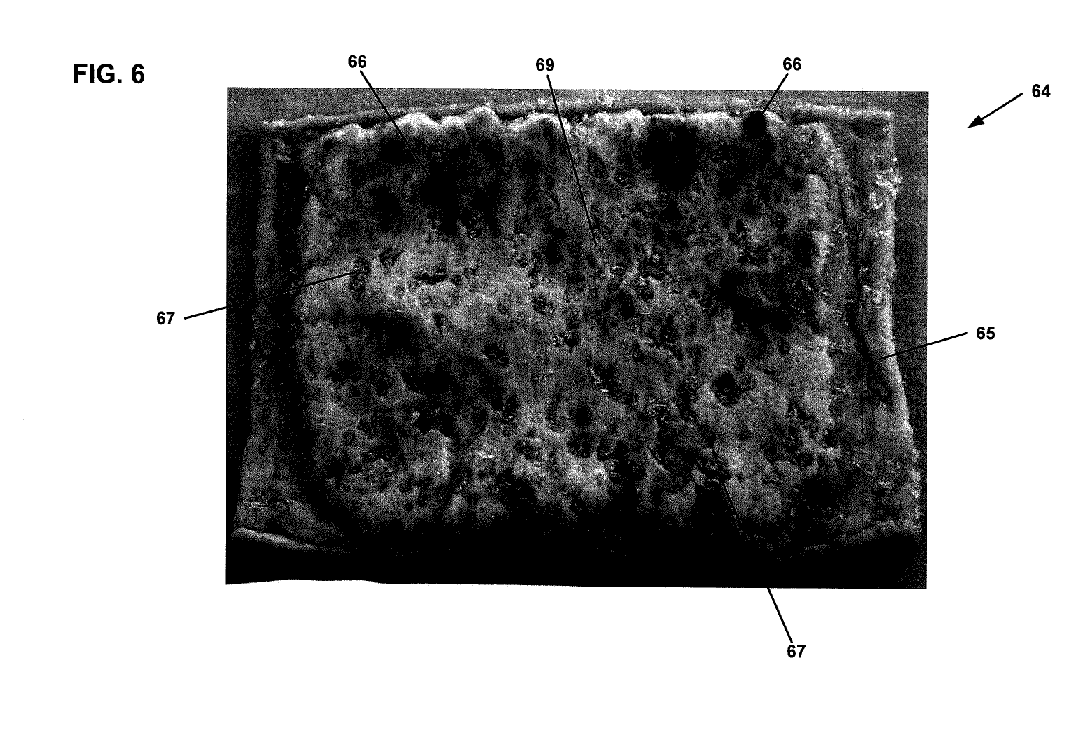

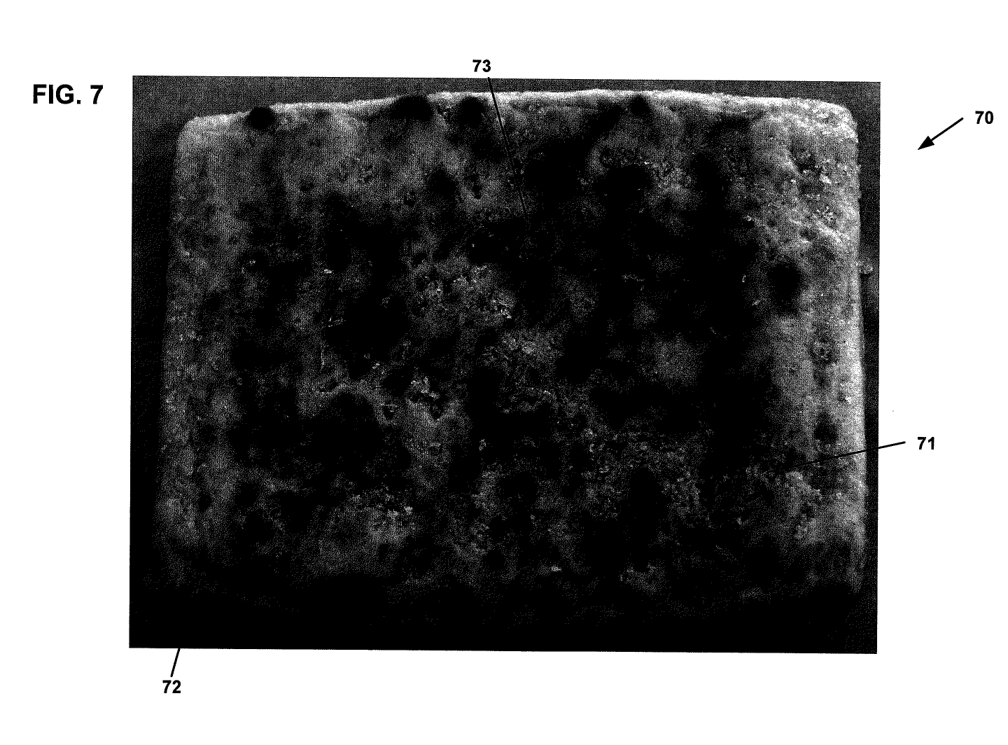

FIGS. 6 and 7 are color photographs of another aspect of the invention. The foods 64 and 70 have sealed edge 65 and 72 forming the planar filled portion 69 and 73. The food has grill marks 66 and embedded bread crumb 67 and 70 throughout the planar filled portion 69.

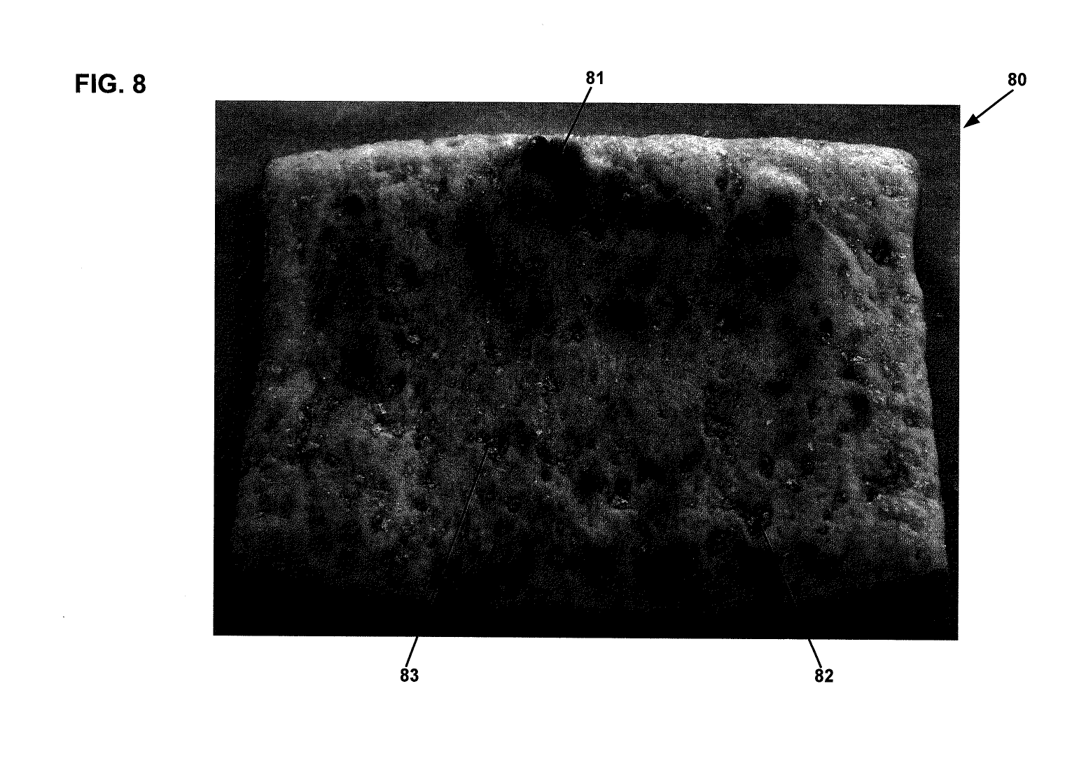

FIG. 8 shows another embodiment of the substantially planar food 80 of the invention. While it is filled is shows no identifiable filled portion and has planar surface 83 throughout. The food 80 has both grill marks 81 and embedded bread crumbs 82 throughout the food.

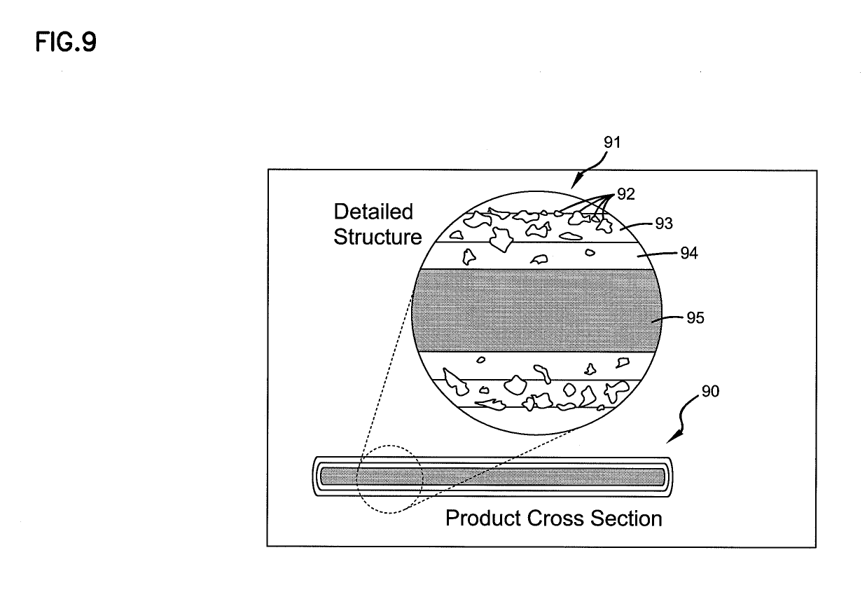

FIG. 9 is a representation 90 of a cross section of the product 91 enclosing a filling 95. In the figure the bread crumbs 92 are shown. The Bread crumbs are imbedded in the surface and are distributed into the crust. As a result of the bread crumb and the processing of the food, the product 90 has a crisp crust layer 93 and a bready or tender crust layer 94.

### EXAMPLE I

### Cheese Filling

| | Percent (%) |
|---|---|
| PROCESSED CHEDDAR CHEESE HI-MELT | 74.32 |
| CHEDDAR CHEESE SAUCE LOW FAT | 24.68 |
| CORNSTARCH | 0.50 |
| DOUGH CONDITIONER | 0.50 |

### Dough

| | Percent (%) |
|---|---|
| FLOUR UNBLEACHED ENRICHED | 58.16 |
| WATER | 32.03 |
| 57% SODIUM-REDUCED SEA SALT | 0.90 |
| SUGAR GRANULATED | 1.16 |
| YEAST COMPRESSED | 2.85 |
| TRANS FATTY ACID FREE SHORTENING | 1.24 |
| SOY PROTEIN ISOLATE | 2.50 |
| EGG (DRIED) WHOLE | 0.01 |
| DOUGH CONDITIONER | 1.15 |
| | 100.00 |

| Description Component | Target Wt. | Target Wt. |
|---|---|---|
| Finished Assembly | (gm) | (oz) |
| Dough from Example II | 70.88 | 2.50 |
| Dusting Flour | 2.84 | 0.10 |
| Cheese Filling from Example I | 28.92 | 1.02 |
| Butter Flavored Soy Oil (spray-on) | 4.25 | 0.15 |
| Toasted Japanese Bread Crumb | 1.42 | 0.05 |
| Totals | 108.30 | 3.82 |

The above specification, examples and data provide a complete description of the manufacture and use of the composition of the invention. Since many embodiments of the invention can be made without departing from the spirit and scope of the invention, the invention resides in the claims hereinafter appended. As used in this specification and the appended claims, the singular forms “a”, “an” and “the” include single and plural referents unless clearly dictated otherwise by specific specification or claim language. Thus, for example, reference to a composition containing “a compound” includes a mixture of two or more compounds.

We claim:

1. A grilled food, the food comprising a substantially planar food having a first surface layer and a second surface layer, each layer comprising a farinaceous composition having a thickness of about 1 to 10 mm, and comprising a about 1 to 6 wt.-% bread crumbs based on the layer, the bread crumbs distributed throughout the thickness of each layer, the layers joined with a sealed edge, the layers having a filling formed therebetween, the food having a square or rectangular edge aspect, the food having a weight of less than 250 grams, a length of about 2 to 15 cm and a width of about 1 to 12 cm, a filling thickness of about 0.1 to 10 millimeters and an overall thickness of 0.5 to 2.5 cm; wherein the first surface layer and the second surface layer comprise exterior indicia of grilled food.

2. The product of claim 1 wherein each first surface layer and second surface layer comprises bread and the bread crumbs comprise a non-uniform distribution in the bread.

3. The product of claim 1 wherein the filling comprises about 25 to 50 grams and comprises a filling selected from a cheese filling, a ham and cheese filling, peanut butter and jelly filling or a pizza filling.

4. The product of claim 1 wherein the bread crumbs have a particle size such that about up to 30 wt.-% of the particles have a diameter of less than about 0.8 mm, about 10 to 70% of the particles have a diameter between about 0.8 to 25 mm and about up to 8% of the particles have a diameter of greater than about 2.5 mm as applied.

5. The product of claim 1 wherein each layer comprises about 2 to 4% bread crumb.

6. The product of claim 2 wherein each bread layer comprises about 200 to 500 grams-m⁻².

7. The product of claim 1 wherein the bread crumbs are imbedded in the surface.

8. A grilled sandwich-like product food, the food comprising a substantially planar food having a first surface layer and a second surface layer, each layer comprising a farinaceous composition having a thickness of about 1 to 10 mm, and comprising a about 1 to 6 wt.-% bread crumbs based on the layer, the bread crumbs distributed throughout the thickness of the each layer, the layers having a sealed edge, the layers having a filling formed therebetween, the food having a substantially circular edge aspect, the food having a weight of less than 250 grams, a having a diameter of about 8 to 15 cm, a filling thickness of about 0.1 to 10 millimeters and an overall thickness of 0.5 to 2 cm; wherein the first surface layer and the second surface layer comprise exterior indicia of grilled food.

9. The product of claim 1 wherein the first surface layer and the second surface layer comprises a bread and the bread crumbs comprise a non-uniform distribution.

10. The product of claim 1 wherein the filling comprises about 25 to 50 grams and comprises a filling selected from a cheese filling, a ham and cheese filling, peanut butter and jelly filling or a pizza filling.

11. The product of claim 1 wherein the bread crumbs have a particle size such that about up to 30 wt.-% of the particles have a diameter of less than about 0.8 mm, about 10 to 70% of the particles have a diameter between about 0.8 to 25 mm and about up to 8% of the particles have a diameter of greater than about 2.5 mm as applied.

12. The product of claim 1 wherein each layer comprises about 2 to 4% bread crumb.

13. The product of claim 2 wherein each bread layer comprises about 200 to 500 grams-m⁻².

14. The product of claim 1 wherein the bread crumbs are imbedded in the surface.

15. A method of making a grilled sandwich-like product food comprising a substantially planar food having a first surface layer and a second surface layer and a sealed edge with a filling formed therebetween, the method comprising sheeting a farinaceous layer, distributing bread crumbs into the layer forming a combined layer, forming a first surface layer and a second surface layer from the combined layer, placing a filling therebetween and a sealing the edge, simultaneously contacting the first surface and the second surface with two spaced apart grill surfaces the grill comprising a first heated surface and a second heated surface, the grill surfaces heated to a temperature sufficient to brown the first and the second surfaces forming a grilled food and directing the grilled food to a baking station wherein the product is baked at a temperature of about 200 to about 450° C. for at least 90 seconds to form the grilled sandwich-like product food product.

16. The method of claim 15 wherein the first heated side and second heated side are at a temperature of about 175 to about 300° C. and the product is heated for a period of 10 to about 50 seconds.

17. The process of claim 15 wherein the first surface and second surface is contacted with oil prior to contact with the grill.

18. The process of claim 15 wherein the farinaceous exterior is formed by sheeting bread dough, dividing the bread dough into portions, adding filling to every other portion to form a plurality of filled portions and a plurality of unfilled portions and forming the food product by adding an unfilled portion to a filled portion, enclosing the filling portion between the food portions and sealing the edge.

19. The method of claim 15 wherein the spaced apart heated surfaces are planar and have an inlet and an outlet and the distance of separation between the spaced apart heated surfaces at the inlet is less than the distance of separation of the spaced apart sides at the outlet.

20. The method of claim 19 wherein the distance of separation of the inlet is about 2 mm to 25 mm and the outlet is more than 5 mm greater than the distance of separation of the inlet.
